(19) United States
(12) Patent Application Publication
(10) Pub. No.: US 2004/0186879 A1
(43) Pub. Date: Sep. 23, 2004

(54) Apparatus and method for setting communication packet

(76) Inventors: Sam Chul Ha, Kyongsangnam-do (KR); Seung Myun Baek, Kyongsangnam-do (KR); Koon Seok Lee, Kyongsangnam-do (KR); Jeong Hyun Lim, Kyongsangnam-do (KR); Hwan Jong Choi, Kyongsangnam-do (KR); Ja In Koo, Kyongsangnam-do (KR); Dae Woong Kim, Kyongsangnam-do (KR); Sung Hwan Kang, Kyongsangnam-do (KR)

Correspondence Address: MCKENNA LONG & ALDRIDGE LLP, 1900 K STREET, NW, WASHINGTON, DC, 20006, US

(21) Appl. No.: 10/481,812

(22) PCT Filed: Apr. 10, 2002
(86) PCT No.: PCT/KR02/00651

(30) Foreign Application Priority Data
Jun. 26, 2001 (KR) P 2001-0036616

(51) Int. Cl. G06F 15/16

(52) U.S. Cl. 709/200

(57) ABSTRACT

An apparatus and method for setting communication packet for a remote control between apparatuses is disclosed, which includes a communication port connected to an external apparatus by a communication bus, a communication circuit for converting signals transmitted/received by the communication port to signals appropriate for the communication bus, a memory for storing data information for communicating, and a microcomputer for controlling the communication circuit and the memory.

### TECHNICAL FIELD

The present invention relates to a home networking system, and more particularly, to an apparatus and method for setting a communication packet for a remote control between apparatuses.

### BACKGROUND ART

A home networking system is a system for controlling home apparatuses such as a PC, a cellular phone, a refrigerator and a washing machine by connecting these apparatuses to each other and thus, by forming one network.

More specifically, the home networking system connects all peripheral apparatuses at home through one main apparatus over a home networking net, and controls them as a whole. Currently, IEEE1394-based and IEC61883-based home network systems are under development.

To realize the home networking system, a protocol for integrating and controlling a number of signals on an IEEE1394-based system is needed to control all peripheral apparatuses through one main apparatus and a user should be able to see the current state of the respective apparatuses. In fact, such protocol is already being developed.

In the home networking system, a communication should be performed between apparatuses with a keyboard and a monitor like a PC and apparatuses without the keyboard and the monitor like a refrigerator and a washing machine. However, because most apparatuses have keys and display devices of only limited functions, they fail to set various conditions required for performing the communication which is realized as the user inputs a key. Accordingly, the apparatuses have limitations in their own operations and in controlling data for communicating with other apparatuses.

### DISCLOSURE OF THE INVENTION

Accordingly, the present invention is directed to an apparatus and method for setting a communication packet for a remote control between apparatuses that substantially obviates one or more problems due to limitations and disadvantages of the related art.

An object of the present invention is to provide an apparatus for setting a communication packet and a method for the same by which a communication of various conditions can be carried out in an apparatus having keys and display devices of limited functions or no display device at all.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for setting a communication packet includes a communication port being connected to an external apparatus by a communication bus, a communication circuit for converting signals transmitted or received by the communication port to signals appropriate for the communication bus, a memory for storing packet data information for communicating, and a microcomputer for controlling the communication port, the communication circuit and the memory.

A method for setting a communication packet includes steps of producing a communication packet for each apparatus using an apparatus having a keyboard and a display device, transmitting the produced communication packet to a corresponding apparatus and storing it in a memory, checking an operation status of the apparatus when it is operated, determining whether communication conditions being stored in the memory accord with the operation status of the checked apparatus by comparing them with each other, and repeating the processes of operating, checking and comparing if the communication conditions do not accord with the operation status of the checked apparatus but performing a communication with the corresponding apparatus by reading the accordant communication packet data from the memory if the communication conditions accord with the operation status of the checked apparatus.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram illustrating a construction of a home networking system in accordance with the present invention;

FIG. 2 is a diagram illustrating a detailed construction of each apparatus in accordance with the present invention;

FIG. 3 is a diagram illustrating a structure of a communication data packet in accordance with the present invention;

FIG. 4 is a diagram illustrating a window for editing a communication data packet in accordance with the present invention;

FIG. 5 is a diagram illustrating a construction of a communication data packet in accordance with an embodiment of the present invention;

FIG. 6 is a diagram illustrating a communication data packet being stored in a memory in accordance with the present invention; and

FIG. 7 is a flow chart illustrating a method for setting a communication packet for a remote control between apparatuses in accordance with the present invention.

### BEST MODE FOR CARRYING OUT THE INVENTION

Reference will now be made in detail to the preferred embodiments of the present invention, examples of which are illustrated in the accompanying drawings.

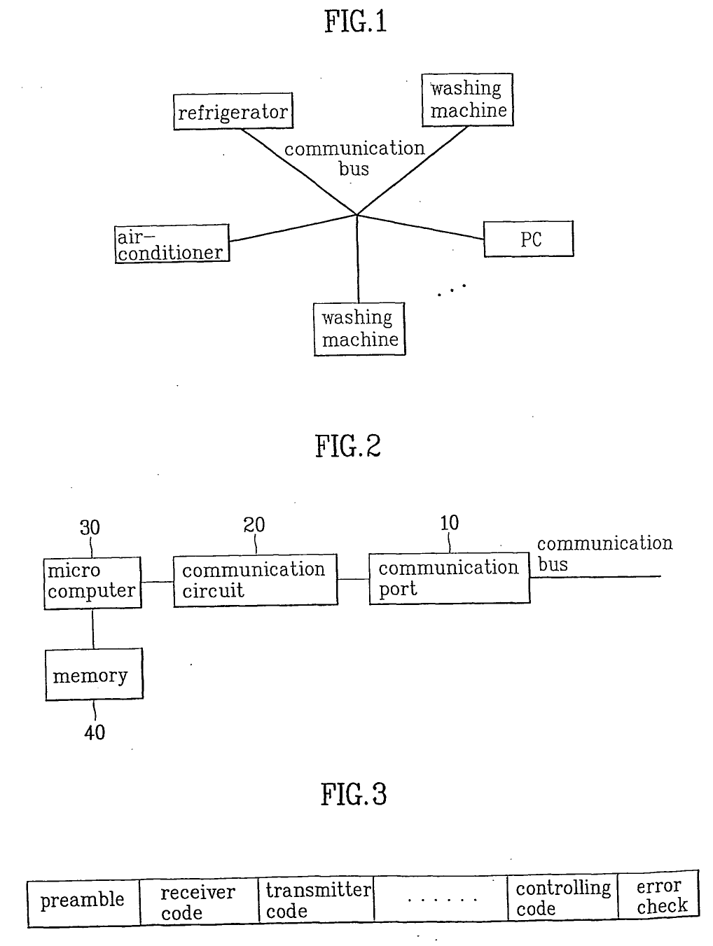

FIG. 1 is a diagram illustrating a construction of a home networking system and FIG. 2 is a diagram illustrating a detailed construction of each apparatus in accordance with the present invention.

As shown in FIG. 1, home apparatuses are connected through a wired or wireless communication bus to form a network. All apparatuses are communicably connected to each other through the communication bus established with the same communication standard. As for the communication standard of the communication bus, an RS-223C-based communication bus is widely being used.

As shown in FIG. 2, each apparatus includes a communication port 10 being connected to an external apparatus by a communication bus, a communication circuit 20 for converting signals transmitted or received by the communication port 10 to signals appropriate for the communication bus, a memory 40 for storing packet data information for communicating, and a microcomputer 30 for controlling the communication port 10, the communication circuit 20, and the memory 40.

As shown in FIG. 3, the packet data being stored in the memory 40 include a preamble, a receiver code, a transmitter code, a controlling code, and an error checking area, which are being set in the memory 40 to be used in the communication between the apparatuses.

At this time, as for the memory, a nonvolatile memory such as an EEPROM or a flash memory is used so that the data in the memory can be modified after being stored.

The apparatus having the packet data being set in the memory performs a communication with an apparatus corresponding to the transmitter code using the transmitter code and controlling code.

An apparatus and method for setting a communication packet for a remote control between apparatuses will be described in detail in accordance with an embodiment of the present invention.

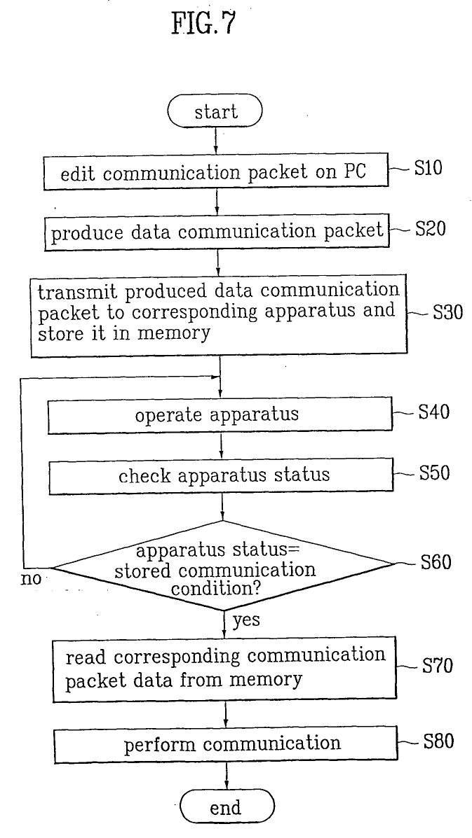

FIG. 7 is a flow chart illustrating a method for setting a communication packet for a remote control between apparatuses in accordance with the present invention.

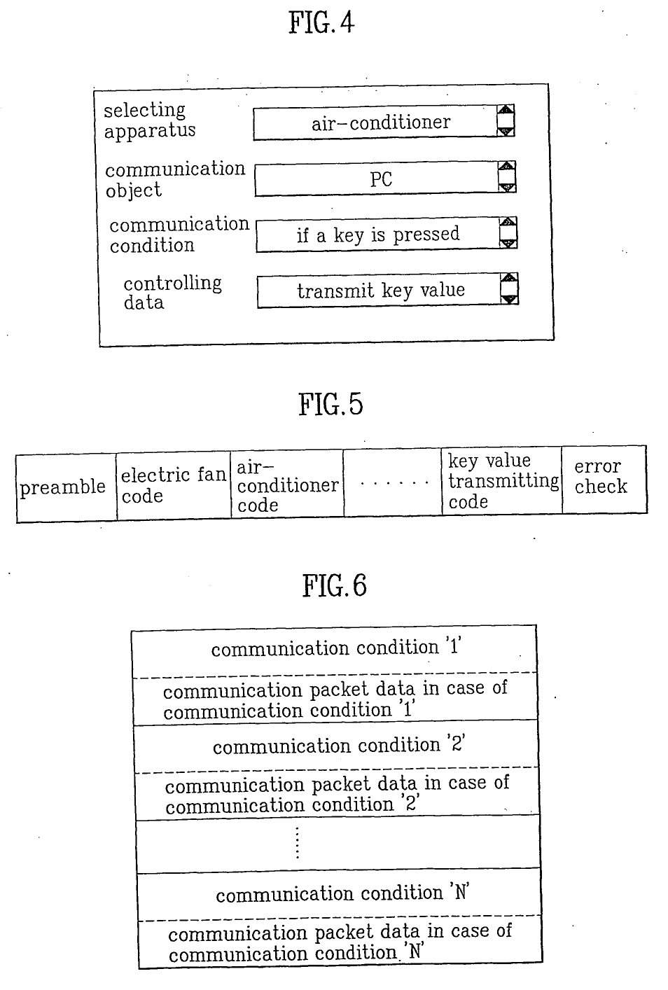

Referring to FIG. 7, a user edits a communication packet using an apparatus (hereinafter, a PC) having a keyboard and a monitor such as a PC. That is, the user inputs “air conditioner” for a selecting apparatus, “electric fan” for a communication object, “if a key is pressed” for a communication condition, and “transmit a key value” for a controlling data on a packet data selecting window of the PC of FIG. 4 (S 10).

When the user inputs on the PC the name of the apparatuses, the communication condition, and the controlling data, as shown in FIG. 5, the PC converts these data to numbers so as to produce an apparatus status code value and a packet required for the communication (S 20).

At this instance, a message that orders the air conditioner to transmit a key value to the electric fan is produced. Accordingly, the packet data of FIG. 5 transmit the key value from the PC to the corresponding apparatus through a communication bus and stores it in the memory (S 30). In this way, the packet data are transmitted to each of the apparatuses through the PC according to the conditions set by the user and as shown in FIG. 6, the packet data are stored in the memory of the corresponding apparatuses. Also, as shown in FIG. 6, the conditions and the communication packet data for performing the communication are stored in the memory.

Then, the respective apparatuses perform their own functions after being turned on (S 40).

When their operations are completed, the apparatuses check their operation statuses (S 50).

Subsequently, the apparatuses compare the packet data conditions being stored in the memory 40 with their current operation statuses to determine if there is any accordant condition (S 60).

If there is no accordant condition, the apparatuses repeat the processes of operating, checking, and comparing. If there is some accordant condition, however, the apparatuses read the accordant communication packet data from the memory (S 70) and perform the communication with the corresponding apparatus (S 80).

For example, if a user operates an air conditioner by pressing a key (S 40), the air conditioner checks its own operation status (S 50) and compares it with a communication condition being stored in a memory (S 60). At this time, as the operation status accords with the stored communication condition, the air conditioner reads the corresponding communication packet data from the memory 40 (S 70). Then, a microcomputer transmits a stop key value to the electric fan (S 80). Finally, the electric fan is turned off by the input stop key value.

### Industrial Applicability

As described above, an apparatus and method for setting a communication packet for a remote control between apparatuses has the following advantages.

The apparatus and method for setting a communication packet according to the present invention makes it possible to perform a communication of various conditions packet according to the present invention makes it possible to perform a communication of various conditions in an apparatus with keys and display devices of only limited functions or no display devices at all.

While the present invention has been described and illustrated herein with reference to the preferred embodiment thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalent.

What is claimed is:

1. An apparatus for setting a communication packet comprising:
a communication port being connected to an external apparatus by a communication bus;
a communication circuit for converting signals transmitted or received through the communication port to signals appropriate for the communication bus;
a memory for storing packet data information required for communicating; and
a microcomputer for controlling the communication port, the communication circuit and the memory.

2. The apparatus of claim 1, wherein the packet data include a preamble, a receiver code, a transmitter code, a controlling code, and an error checking area.

3. The apparatus of claim 1, wherein the memory is a nonvolatile memory such as an EEPROM or a flash memory.

4. The apparatus of claim 1, wherein the communication bus is RS-232C-based one.

5. A method for setting a communication packet, comprising steps of:
producing a communication packet for each apparatus using an apparatus having a keyboard and a display device;
transmitting the produced communication packet to a corresponding apparatus and storing it in a memory;
checking an operation status of the apparatus when it is operated;
determining whether a communication condition being stored in the memory accords with the operation status or the checked apparatus by comparing them with each other; and
repeating the processes of operating, checking and comparing if the communication condition does not accord with the operation status of the checked apparatus but performing a communication with the corresponding apparatus by reading the accordant communication packet data from the memory if the communication condition accords with the operation status of the checked apparatus.

6. The method of claim 5, wherein the step of producing the communication packet for each of the apparatuses includes steps of:
inputting a selecting apparatus, a communication object, a communication condition, and controlling data on a window for selecting the communication packet; and
converting the letter information input in the previous step to codes to produce a code value and a packet.

7. The method of claim 5, wherein the communication packet being stored in the memory includes the communication condition and the communication packet data required for performing the communication.
